(19) United States
(12) Patent Application Publication
(10) Pub. No.: US 2004/0178161 A1
(43) Pub. Date: Sep. 16, 2004

(54) Interconnecting container assembly

(76) Inventor: Svetlana Galustyan, Sherman Oaks, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/692,036

(22) Filed: Oct. 22, 2003

Related U.S. Application Data
(60) Provisional application No. 60/454,945, filed on Mar. 13, 2003.

(51) Int. Cl. A61J 9/00; B65D 85/62; B65D 21/00; A61J 11/00

(52) U.S. Cl. 215/11.1; 220/4.27; 206/499; 206/508

(57) ABSTRACT

An interconnecting container assembly includes a plurality of hollow containers aligned along a common axis where each container includes a threaded opening on a first end and a threaded recess on a second end. A removable dispensing cap matingly engages the threaded opening on at least one of the plurality of hollow containers. Alternatively, the interconnecting container assembly includes a plurality of hollow containers aligned end-to-end along a common axis where each container includes a threaded dispensing cap on a first end and a threaded recess on a second end. The threaded dispensing cap on at least one of the plurality of hollow containers matingly engages the threaded recess of one of the remaining plurality of hollow containers.

### RELATED APPLICATION

This application claims priority from provisional application Serial No. 60/454,945, filed Mar. 13, 2003.

### BACKGROUND OF THE INVENTION

The present invention relates to containers for holding substances, such as foods and fluids. More particularly, the present invention relates an interconnecting container assembly in which two or more containers may be held together rigidly in tandem relationship for transportation and storage. Containers for holding substances, such as fluids and other food substances, are well known in the art. However, containers which securely attach to one another in the tandem relationship for transportation and storage of substances are not as pervasive.

Interconnecting containers have been devised, typically in the form of baby bottles, which comprise adjoining segments to enlarge the capacity of the dispensing container. However, these containers do not allow for the storage or transportation of different substances. For example these interconnecting containers do not permit transporting both baby formula and juice or ketchup and mustard.

Other adjoining containers use exterior collars or clamps for connecting one or more containers in tandem. However, when these collars or clamps are not in use, such as when only one of the containers is being used or access is sought to one of the containers, the clamp or collar must be kept track of and stored for later use.

Yet other tandem containers are very specific in nature such as the integrated contact lens-maintenance kit carrying apparatus of U.S. Pat. No. 4,529,786 to Hucal or the dual thermos of U.S. Pat. No. 5,086,926 to Paige et al.

Accordingly, there is a need for an interconnecting container assembly which allows the storage and/or transportation of different substances within the tandem containers. Such an assembly should provide for the storage of a variety of substances, such as milk, juice, ketchup, oil, etc. The present invention fulfills these needs and provides other related advantages.

### SUMMARY OF THE INVENTION

With the foregoing needs in mind, it is an object of the present invention to provide a interconnecting container assembly adapted to hold two or more containers rigidly together in tandem relationship for transportation. Another object of the present invention is the provision of an interconnecting container assembly which can be quickly and easily assembled and disassembled.

Still another object of the present invention is the provision of an interconnecting container assembly wherein the individual containers are fluidly sealed from one another.

In accordance with the objects and needs of the present invention, an interconnecting container assembly is provided wherein multiple containers can be joined to one another in tandem without fluid communication between the containers for transportation and storage of a variety of substances. In one form of the invention, the assembly provides for the interconnecting of containers having a spout or nipple at one end thereof.

One embodiment of the interconnecting container assembly includes a plurality of hollow containers aligned along a common axis. Each container includes a threaded opening on a first end and a threaded recess on a second end. There is also a removable dispensing cap matingly engaging the threaded opening on at least one of the plurality of hollow containers.

The hollow containers are aligned end-to-end along the common axis. The threaded opening includes a threaded neck extending from the first end.

The threaded recess of at least one of the plurality of hollow containers matingly engages the threaded opening of another container of the plurality of hollow containers. The threaded recess is shaped to compliment the shape of the threaded opening.

The dispensing cap includes a dispensing spout which can be a drinking nipple.

The second end of a first container of the plurality of hollow containers is adjacent to the first end of a second container of the plurality of hollow containers when the threaded opening of the second container is matingly engaged with the threaded recess of the first container. The threaded recess of the first container seals the threaded opening of the second container when the first container is mated to the second container.

Another embodiment of the interconnecting container assembly includes a plurality of hollow containers aligned end-to-end along a common axis. Each container includes a threaded dispensing cap on a first end and a threaded recess on a second end. The threaded dispensing cap on at least one of the plurality of hollow containers matingly engages the threaded recess of one of the remaining plurality of hollow containers.

The threaded dispensing cap includes a dispensing spout which can be a drinking nipple.

The threaded recess is shaped to compliment the shape of the threaded dispensing cap. When the dispensing cap includes a drinking nipple, the threaded recess and threaded dispensing cap are generally nipple-shaped.

The second end of a first container of the plurality of hollow containers is adjacent the first end of a second container of the plurality of hollow containers when the threaded dispensing cap of the second container matingly engages the threaded recess of the first container.

Other objects and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of an interconnecting container assembly in accordance with the present invention.

FIG. 2 is an exploded perspective view of the interconnecting container assembly of FIG. 1;

FIG. 3 is an exploded perspective view of a single container utilized in the assembly of the present invention;

FIG. 4 is a partially fragmented perspective view of a container similar to FIG. 3, illustrating a recess formed in a base thereof;

FIG. 5 is a partially exploded and partially fragmented perspective view of the assembly of FIGS. 1 and 2;

FIG. 6 is a perspective view of another interconnecting container assembly embodying the present invention;

FIG. 7 is an exploded perspective view of the assembly of FIG. 6;

FIG. 8 is an exploded and partially fragmented perspective view of two containers securable in tandem to form the assembly of similar to FIG. 6; and

FIG. 9 is a partially exploded and partially fragmented perspective view of the assembly of FIGS. 6 and 7, illustrating a recess formed in each container conforming to a spout extending from the container attached in tandem thereto.

### DETAILED DESCRIPTION OF THE PREFERRED EMBODIMENTS

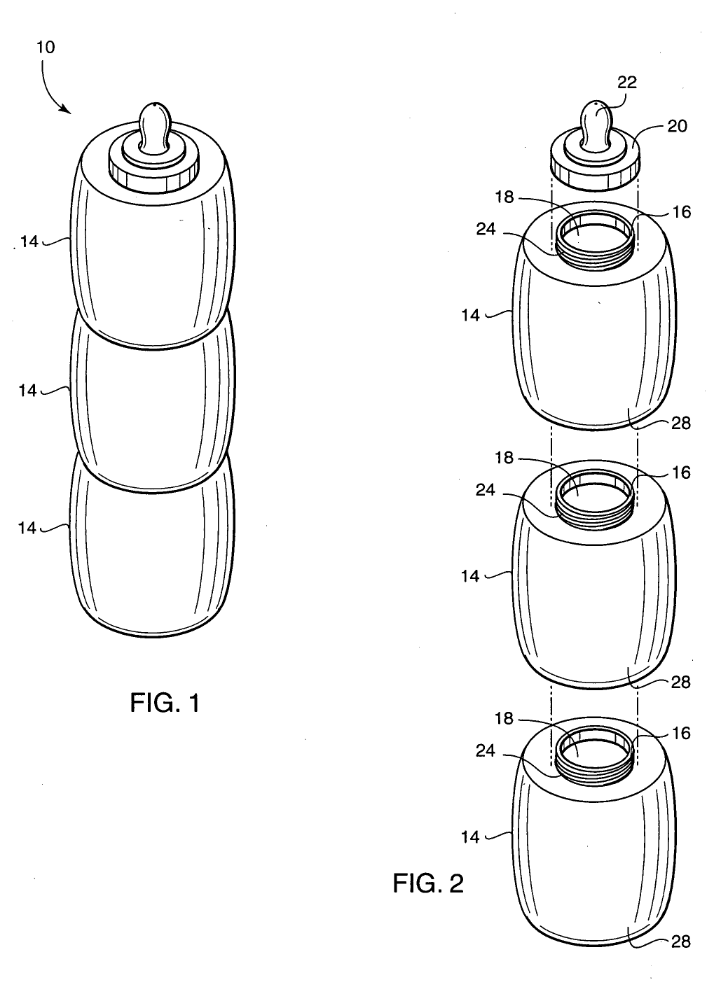

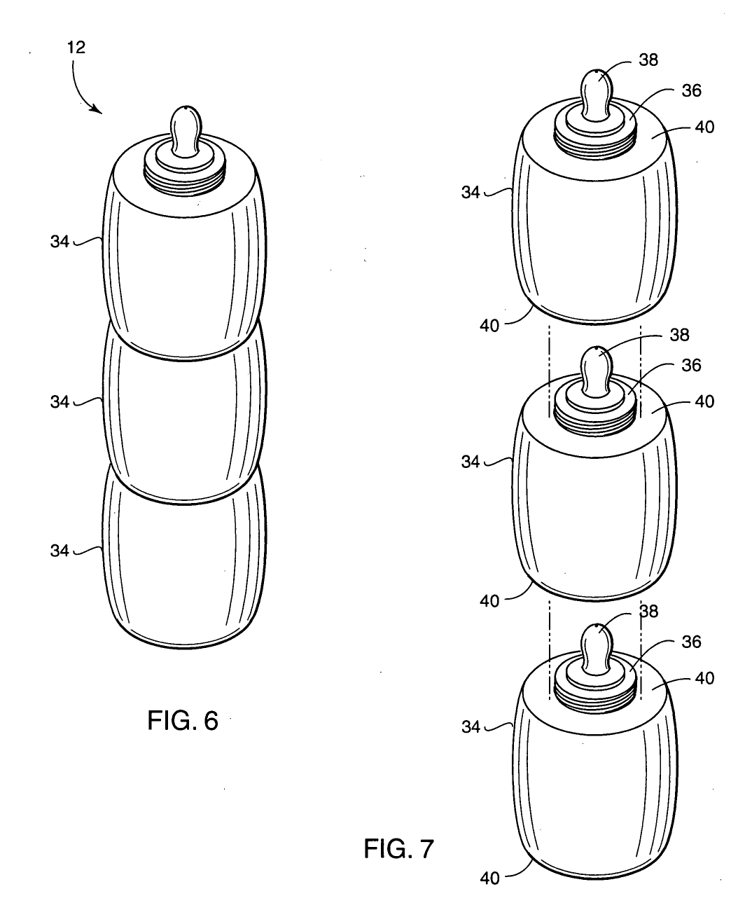

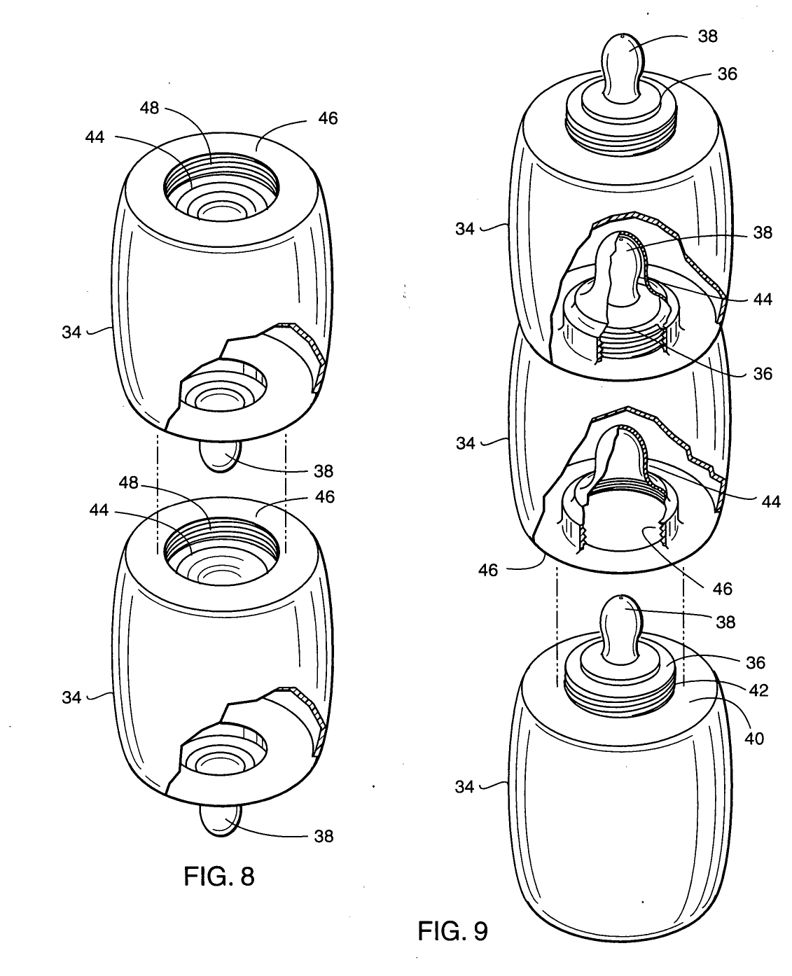

As shown in the drawings for purposes of illustration, the present invention is concerned with an interconnecting container assembly generally referred to by the reference number 10 in FIGS. 1-5, and by the reference number 12 in FIGS. 6-9.

With reference to FIGS. 1 and 2, the assembly 10 is comprised of multiple hollow containers 14 interconnected end to end. The containers 14 can be of varying sizes and shapes, although preferably they comprise elongated cylinders as shown in the drawings. Preferably, the containers 14 are comprised of hardened plastic, although other rigid materials such as glass or metal may be used.

Each container 14 includes an externally threaded neck 16 which is smaller in diameter than the container 14 and extends upwardly therefrom. The neck 16 defines an outlet orifice 18 of the container 14. A cap 20 bearing a dispensing spout 22, such as the illustrated baby bottle nipple, is threadably attachable to exterior threads 24 of neck 16. It is to be appreciated that the spout 22 can be modified as needed to dispense the fluid contents of the upper most container 14 of the assembly 10. For example, different spouts may be required for use of baby milk, oil, vinegar, mustard, or ketchup.

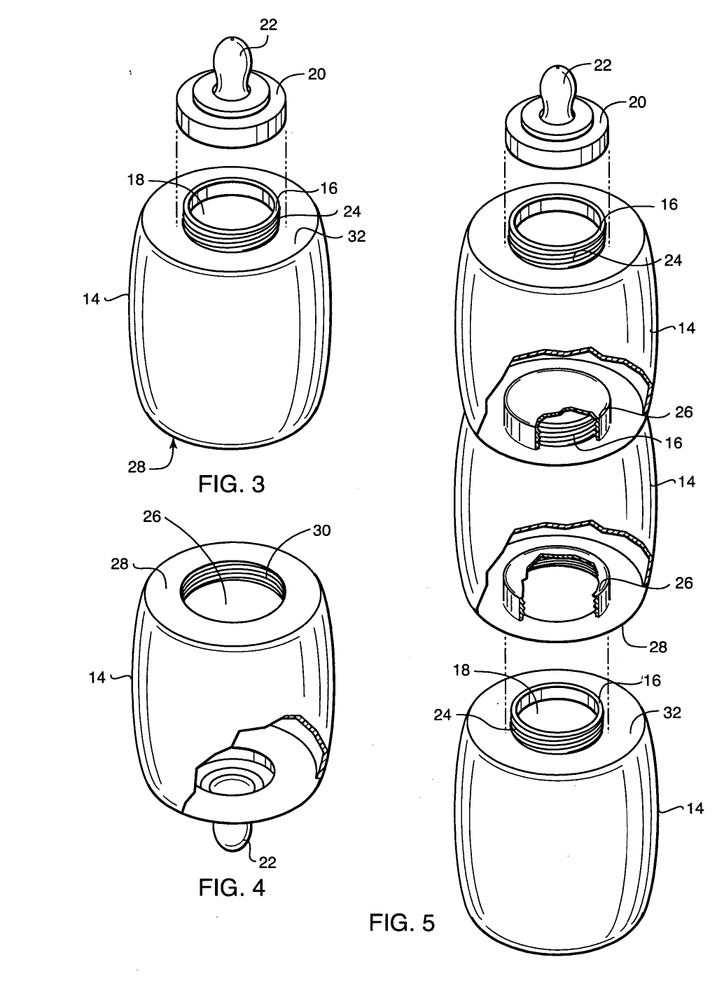

Referring now to FIGS. 3-5, each container 14 includes a recess 26 formed in a base 28 of the container 14 opposite the neck 16. The recess 26 includes internal threads 30 and is configured and sized to receive in mating fashion a neck 16 of an adjoining container 14.

As illustrated in FIG. 5, the recess 26 is formed integrally with the container 14 so as not to provide for fluid communication between the adjoining containers 14. Thus, different substances can be stored within the various containers without concern of mixture of the substances. In this fashion, the uppermost container 14 can hold babies milk, for example, while lower containers 14 include juice, cereal, or the like. The containers 14 are preferably configured such that when a neck 16 of a lower container is inserted into the recess 26, the base 28 of the upper container and the top surface 32 of the lower container conform to one another to form a unified appearing structure.

In use, the cap 20 and accompanying spout 22 are attached to the neck 16 of a first container 14. Alternatively, a cap 20 which forms a sealed lid may be used to prevent the dispensing of the contents of the first container 14. A subsequent number of containers 14 are attached to one another in tandem by inserting the neck 16 into the recess 26 of the adjoining container 14 and twisting the containers together until secured. Two or more containers may be adjoined in tandem in such a manner as dictated by the needs of the user. As illustrated, a cap 20 having a spout 22 in form of a baby nipple is attached to the uppermost container 14. After the baby has drank the contents of the uppermost container, this container can be removed by untwisting it from its adjoining container 14 and the nipple removed so that the empty container 14 can be inserted into the bottom most container in the stack 14. The now uppermost container 14 may hold the same liquid or a different liquid, such as juice instead of baby milk, to which the nipple can be attached for feeding the baby.

Referring now to FIGS. 6-9, another assembly 12 embodying the present invention is illustrated wherein each of the containers 34 have a cap 36 and spout 38 attached thereto and extending from an upper surface 40 thereof. Each cap includes external threads 42 for connection to an adjoining container as will be more fully described herein. A recess 44 is formed at the base 42 of each container 30 generally opposite the cap thereof.

As illustrated in FIG. 9, the recess 44 is integrally formed with a base 46 of the container 34 so as to conform to the cap 36 and spout 38 of an adjoining container 34. The recesses 44 are formed such that there is no fluid communication between adjoining containers 34. The recesses 44 also include internal threads 48 which receive the external threads 42 of the cap 36. The upper surface 40 and base 46 of each container 34 are configured such that when the containers 34 are interconnected, a uniform appearing structure is provided.

In use, the containers 34 may be of a one-use and disposable nature. These disposable containers 34 can be interconnected as described above and used as needed. Alternatively, the cap 36 and spout 38 can be removed for the addition of fluid or the like within the container 34 and then reattached for interconnection with other containers 34. In this manner, when the contents of the uppermost container 34 have been dispensed, the uppermost container 34 can be removed and the next container in sequence is ready for immediate use without transfer of the cap 36 and spout 38. Thus, an oil and vinegar assembly 12 can be created wherein oil can first be dispensed from the upper container and then the upper container removed to dispense vinegar from a lower container 34. The containers 34 can be reattached to one another for convenient and aesthetically pleasing storage and transportation.

In the alternative, the containers 14, 34 may be different sizes, stacked one atop each other. For example, the largest container 14, 34 may be placed on the bottom of the stack and the smallest container 14, 34 placed at the top of the stack. Containers 14, 34 of incrementally increasing/decreasing size (depending on whether the view is looking from bottom-to-top or top-to-bottom) may be located between the largest and smallest container.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

What is claimed is:

1. An interconnecting container assembly, comprising:
a plurality of hollow containers aligned along a common axis, each container including a threaded opening on a first end and a threaded recess on a second end; and
a removable dispensing cap matingly engaging the threaded opening on at least one of the plurality of hollow containers.

2. The interconnecting container assembly of claim 1, wherein the hollow containers are aligned end-to-end along the common axis.

3. The interconnecting container assembly of claim 1, wherein the threaded opening includes a threaded neck extending from the first end.

4. The interconnecting container assembly of claim 1, wherein the threaded recess of at least one of the plurality of hollow containers matingly engages the threaded opening of another container of the plurality of hollow containers.

5. The interconnecting container assembly of claim 1, wherein the dispensing cap includes a dispensing spout.

6. The interconnecting container assembly of claim 5, wherein the dispensing spout is a drinking nipple.

7. The interconnecting container assembly of claim 1, wherein the threaded recess is shaped to compliment the shape of the threaded opening.

8. The interconnecting container assembly of claim 1, wherein the second end of a first container of the plurality of hollow containers is adjacent to the first end of a second container of the plurality of hollow containers when the threaded opening of the second container is matingly engaged with the threaded recess of the first container

9. The interconnecting container assembly of claim 8, wherein the threaded recess of the first container seals the threaded opening of the second container when the first container is mated to the second container.

10. An interconnecting container assembly, comprising:
a plurality of hollow containers aligned end-to-end along a common axis, each container including a threaded opening on a first end and a threaded recess on a second end, wherein the threaded recess is shaped to compliment the shape of the threaded opening; and
a removable dispensing cap matingly engaging the threaded opening on at least one of the plurality of hollow containers; wherein the threaded opening includes a threaded neck extending from the first end, the dispensing cap includes a drinking nipple, the second end of a first container of the plurality of hollow containers is adjacent to the first end of a second container of the plurality of hollow containers when the threaded opening of the second container is matingly engaged with the threaded recess of the first container, and the threaded recess of the first container seals the threaded opening of the second container when the first container is mated to the second container.

11. An interconnecting container assembly, comprising:
a plurality of hollow containers aligned along a common axis, each container including a threaded dispensing cap on a first end and a threaded recess on a second end; and
wherein the threaded dispensing cap on at least one of the plurality of hollow containers matingly engages the threaded recess of one of the remaining plurality of hollow containers.

12. The interconnecting container assembly of claim 11, wherein the plurality of hollow containers are aligned end-to-end along the common axis.

13. The interconnecting container assembly of claim 11, wherein the threaded dispensing cap includes a dispensing spout.

14. The interconnecting container assembly of claim 13, wherein the dispensing spout is a drinking nipple.

15. The interconnecting container assembly of claim 11, wherein the threaded recess is shaped to compliment the shape of the threaded dispensing cap.

16. The interconnecting container assembly of claim 15, wherein the threaded recess and threaded dispensing cap are generally nipple-shaped.

17. The interconnecting container assembly of claim 11, wherein the second end of a first container of the plurality of hollow containers is adjacent the first end of a second container of the plurality of hollow containers when the threaded dispensing cap of the second container matingly engages the threaded recess of the first container.

18. An interconnecting container assembly, comprising:
a plurality of hollow containers aligned end-to-end along a common axis, each container including a threaded dispensing cap on a first end and a threaded recess on a second end; wherein the threaded dispensing cap includes a drinking nipple, the threaded recess is generally nipple-shaped to compliment the threaded dispensing cap, and the second end of a first container of the plurality of hollow containers is adjacent to the first end of a second container of the plurality of hollow containers when the threaded dispensing cap of the second container matingly engages the threaded recess of the first container.
